(19) United States
(12) Patent Application Publication
(10) Pub. No.: US 2014/0327580 A1
(43) Pub. Date: Nov. 6, 2014

(54) Using Measured Angular Coordinates of an Object Relative to a Directional Transceiver

(71) Applicant: Terhi Rautiainen, Vantaa (FI)

(72) Inventor: Terhi Rautiainen, Vantaa (FI)

(73) Assignee: Noka Corporation, Espoo (FI)

(21) Appl. No.: 14/346,049

(22) PCT Filed: Sep. 27, 2011
(86) PCT No.: PCT/IB2011/054249

§ 371 Date: Jun. 27, 2014

(51) Int. Cl. G01S 5/02

(52) U.S. Cl. CPC G01S 5/02
USPC 342/385

(57) ABSTRACT

A method comprises measuring angular coordinates of an object (12) relative to a directional transceiver (10), the directional transceiver being at a first location relative to a reference coordinate system and having an orientation relative to the reference coordinate system, the object (12) being at a second, known location, the angular coordinates (θ_{A}, Φ_{A}) being measured relative to an axis of a local coordinate system, the orientation of the local coordinate system being defined by the orientation of the directional transceiver (10) and the origin of the local coordinate system being at the first location, wherein at least one of the first location and the orientation of the directional transceiver are unknown, and calculating the unknown at least one of the first location and the orientation of the directional transceiver using the angular coordinates (θ_{A}, Φ_{A}).

### FIELD

The invention relates to the use of measured angular coordinates of an object relative to a directional transceiver.

### BACKGROUND

There are a number of known techniques for determining the position of an apparatus using radio frequency signals. Some popular techniques relate to use of the Global Positioning System (GPS), in which multiple satellites orbiting Earth transmit radio frequency signals that enable a GPS receiver to determine its position. However, GPS is often not very effective in determining an accurate position indoors.

Some non-GPS positioning techniques enable an apparatus to determine its position indoors. However, many of these techniques do not result in an accurate position being determined, and others suffer from other disadvantages.

### SUMMARY

According to a first aspect, this specification describes a method comprising determining angular coordinates of an object relative to a directional transceiver, the directional transceiver being at a first location relative to a reference coordinate system and having an orientation relative to the reference coordinate system, the object being at a second, known location, the angular coordinates being relative to an axis of a local coordinate system, the orientation of the local coordinate system being defined by the orientation of the directional transceiver and the origin of the local coordinate system being at the first location, wherein at least one of the first location and the orientation of the directional transceiver are unknown, the method further comprising calculating the unknown at least one of the first location and the orientation of the directional transceiver using the angular coordinates.

According to a second aspect, this specification describes an apparatus comprising at least one processor and at least one memory, the at least one memory having stored thereon computer-readable instructions which, when executed by the at least one processor, cause the at least one processor to receive signals indicative of angular coordinates of an object relative to a directional transceiver, the directional transceiver being at a first location relative to a reference coordinate system and having an orientation relative to the reference coordinate system, the object being at a second, known location relative to the reference coordinate system, the angular coordinates being measured relative to an axis of a local coordinate system, the orientation of the local coordinate system being defined by the orientation of the directional transceiver and the origin of the local coordinate system being at the first location, wherein at least one of the first location and the orientation of the directional transceiver are unknown, and to calculate the unknown at least one of the first location and the orientation of the directional transceiver using the angular coordinates.

According to a third aspect, this specification describes a non-transitory computer-readable medium having stored thereon computer-readable instructions which, when executed by computing apparatus, cause the computing apparatus to determine angular coordinates of an object relative to a directional transceiver, the directional transceiver being at a first location relative to a reference coordinate system and having an orientation relative to the reference coordinate system, the object being at a second, known location relative to the reference coordinate system, the angular coordinates being relative to an axis of a local coordinate system, the orientation of the local coordinate system being defined by the orientation of the directional transceiver and the origin of the local coordinate system being at the first location, wherein at least one of the first location and the orientation of the directional transceiver are unknown, and to calculate the unknown at least one of the first location and the orientation of the directional transceiver using the angular coordinates.

According to a fourth aspect, this specification describes apparatus comprising means for causing angular coordinates of an object relative to a directional transceiver to be measured, the directional transceiver being at a first location relative to a reference coordinate system and having an orientation relative to the reference coordinate system, the object being at a second, known location, the angular coordinates being measured relative to an axis of a local coordinate system, the orientation of the local coordinate system being defined by the orientation of the directional transceiver and the origin of the local coordinate system being at the first location, wherein at least one of the first location and the orientation of the directional transceiver are unknown, the apparatus further comprising means for calculating the unknown at least one of the first location and the orientation of the directional transceiver using the angular coordinates.

According to a fifth aspect, this specification describes computer-readable code which, when executed by computing apparatus, causes the computing apparatus to perform a method according to the first aspect.

According to a sixth aspect, this specification describes apparatus configured to determine angular coordinates of an object relative to a directional transceiver, the directional transceiver being at a first location relative to a reference coordinate system and having an orientation relative to the reference coordinate system, the object being at a second, known location, the angular coordinates being relative to an axis of a local coordinate system, the orientation of the local coordinate system being defined by the orientation of the directional transceiver and the origin of the local coordinate system being at the first location, wherein at least one of the first location and the orientation of the directional transceiver are unknown, the apparatus being further configured to calculate the unknown at least one of the first location and the orientation of the directional transceiver using the angular coordinates.

### BRIEF DESCRIPTION OF THE FIGURES

For a more complete understanding of example embodiments of the present invention, reference is now made to the following description taken in connection with the accompanying drawings in which:

FIG. 1 is a schematic illustration of a directional transceiver and an object, showing both a local coordinate system relative to the directional transceiver and a reference coordinate system;

FIG. 2 is an illustrative schematic of a system for enabling the post-installation determination of the location and orientation of a directional transceiver relative to a reference coordinate system;

FIG. 3 is a flow chart illustrating methods and operations according to some example embodiments; and

FIGS. 4A to 4C depict results of computer simulations of methods according to some example embodiments.

### DETAILED DESCRIPTION

In the description and drawings, like reference numerals refer to like elements throughout.

Positioning packets of a mobile apparatus can be used to determine and track the position of a mobile apparatus in any area provided with a suitable infrastructure. The mobile apparatus may be for instance a location tag that is to be used for asset tracking. It may alternatively be a more complex device.

Positioning making use of positioning packets can be used for instance for achieving accurate positioning indoors; it may enable a resolution of down to 30 cm. It may be based for instance on low cost Bluetooth Low Energy (BT LE) technology, which is a feature of the Bluetooth 4.0 technology being standardized by the Bluetooth Special Interest Group (SIG).

A positioning system making use of periodic BT LE transmissions can be used with smart devices that locate themselves using a BT LE signal emitted by directional transceivers (DT). This may be referred to as “downlink” mode. DTs are also referred to as beacons. DTs are generally comprised of multiple antennas provided in an array. In downlink mode, the DT may transmit a signal sequentially using several antennas and the smart device receives this using a single antenna. The smart device can calculate its direction vector (or bearing) from the DT if it knows the DT antenna switching pattern of the transmitted signal and the DT antenna array calibration pattern.

Alternatively, a reversed mode of operation can be used. In this “asset tracking” or “uplink” mode, BT LE transceivers that are referred to as tags or location tags emit a signal that is picked up by DTs. The signal is a data packet that enables a DT to identify the tag. The packet may be referred to as a positioning packet. The positioning packet has a form that allows the DT (or another device) to calculate the direction vector (bearing) from the DT towards the tag using a reception of the signal by multiple antennas of the DT. This process is also referred to as “tag update”. An HDP (high definition positioning) infrastructure behind the DTs may calculate the position of the tag.

The position of the device may be calculated using the known location and orientation of one DT and a bearing to the tag from the DT, optionally with constraint information. Position may be calculated based on the bearings determined by two, three or more DTs using triangulation. The HDP infrastructure may comprise to this end a positioning server that contains data buffering and position calculation functions. Additionally, the HDP infrastructure may contain various management and application servers.

Location tags supporting the second operating mode can be particularly small and inexpensive, and they may be attached to any desired moving object. A location tag may comprise for instance a battery, some logic in the form of a microcontroller and radio parts. It may be configured to periodically transmit a signal in order to enable determination of positions of the tag. The positions may be used, for instance, for tracking an object to which the tag is associated. Typical frequencies of transmissions and thus of enabled location updates are 1, 10 or 50 times per second.

While the positioning of a mobile apparatus by means of positioning packets of the mobile apparatus can be realized in a positioning system using BT LE, it is to be understood that a similar approach can be used with various other systems and transmission technologies, for instance with a positioning system using active radio frequency identification (RFID).

As described above, in order for the location of the device or tag to be determined, the location and orientation of the directional transceiver (DT) with which the tag or device is communicating must be known. The location and orientation of the directional transceivers may be determined separately for each transceiver during installation of the transceiver. However, typical positioning systems comprise plural directional transceivers. As such, determination of the location and orientation of each individual directional transceiver during installation can be a laborious and slow process. Alternatively, the directional transceivers can be installed at predefined locations and having a predefined orientation. However, not only does this require a very high degree of accuracy during installation, it also requires that suitable installation sites having appropriate locations and orientations are available, and this is not always possible.

Example embodiments described herein allow the location and orientation of a directional transceiver to be determined after installation of the directional transceiver. Consequently, the need for the directional transceivers to be installed at a known location and having a known orientation is may be obviated. In addition, it is also not necessary accurately to measure the orientation and location of the directional transceiver during installation.

Some example embodiments also allow the locations and orientations of multiple directional transceivers in a positioning system to be determined concurrently.

According to some example embodiments, a method is provided for calibrating an in-field positioning system comprising a directional transceiver installed at a first location and having a particular orientation. Initially, immediately after installation, the first location and the orientation, which are relative to a reference coordinate system, are not known.

The method comprises measuring, using the directional transceiver 10, angular coordinates of an object 12 relative to the directional transceiver 10. The object 12 may be, for example, a tag or device as described above. The object 12 is at a second, known location relative to the reference coordinate system. As the orientation of the directional transceiver 10 relative to the reference coordinate system is initially unknown, the angular coordinates of the object 12 are measured relative to an axis of a coordinate system that is local to the directional transceiver 10. The orientation of the local coordinate system, and thus also the orientation of the axis of the local coordinate system, is defined by the orientation of the directional transceiver 10.

The method then comprises using the angular coordinates of the object 12 to calculate the first location and the orientation of the directional transceiver 10 relative to the reference coordinate system.

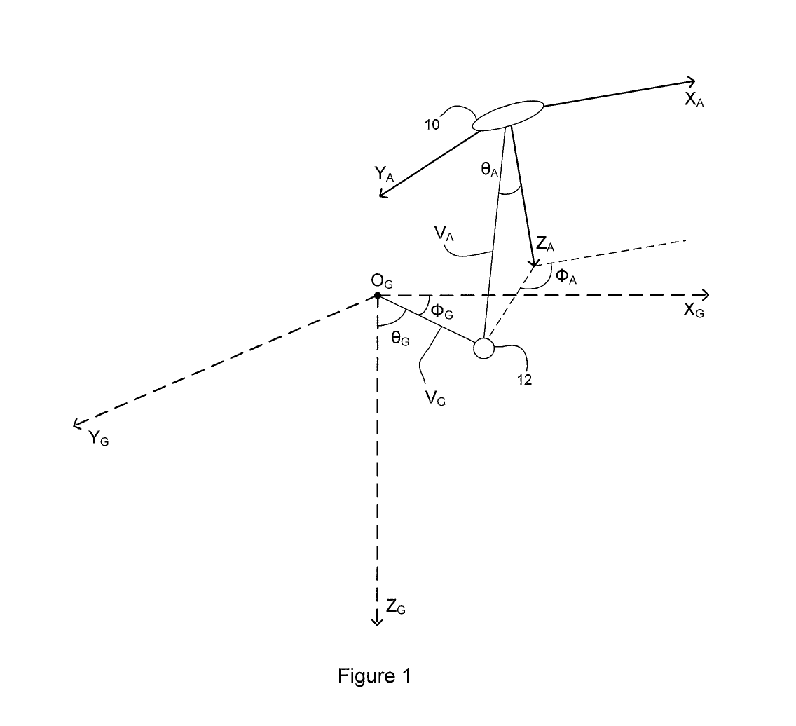

FIG. 1 is a schematic illustration of the directional transceiver 10 and the object 12 when determining the location and orientation of the directional transceiver 10 relative to the reference coordinate system. The reference coordinate system is denoted by the three dashed axis, labelled X_{G}, Y_{G}, Z_{G}. The local coordinate system of the directional transceiver 10 is shown by the solid axis labelled X_{A}, Y_{A}, Z_{A}. The vector from the directional antenna to the object 12 is labelled V_{A}. The orientation of the local coordinate system is defined by the orientation of the directional transceiver 10. The origin of the local coordinate system is at the location of the directional transceiver 10.

In the illustration of FIG. 1, for ease of understanding, simulation and calculation, the reference coordinate system is defined such that the object 12 is located at Z_{G}=0.

The angular coordinates of the object 12 relative to the directional transceiver 10 are shown as θ_{A} and θ_{A}. θ_{A} is the angle of the vector V, with the Z_{A} axis. Φ_{A} is the angle between the projection of the vector V_{A} in the X_{A}-Y_{A} plane and the X_{A} axis respectively.

The vector from the origin of the reference coordinate system O_{G} to the object 12 is denoted V_{G}. The angular coordinates of the object 12 relative the origin of the reference coordinate system O_{G} are denoted as θ_{G} and Φ_{G}. θ_{G} is the angle of the vector V_{G} with the Z_{G} axis. Φ_{G} is the angle between the projection of the vector V_{G} in the X_{G}-Y_{G} plane and the X_{G} axis respectively.

Although not shown on FIG. 1, the location of the object 12 relative to the reference coordinate system may be generally denoted as (x_{G}, y_{G}, z_{G}). However, as in this example the object 12 is located at z_{G}=0, the location of the object 12 relative to the reference coordinate system can be written as (x_{G}, y_{G}, 0).

The location of the directional transceiver 10 relative to the reference coordinate system may be denoted as (a₀, b₀, c₀).

As discussed above, a method for determining the location and orientation of an installed directional transceiver 10 relative to a reference coordinate system comprises using the directional transceiver 10 to measure the angular coordinates θ_{A} and Φ_{A} of an object 12 at a known location, (x_{G}, y_{G}, 0). Next, the known location of the object 12 and the measured angular coordinates θ_{A}, Φ_{A} are used to calculate the location and orientation of the directional transceiver 10.

The following is a mathematical explanation as to how the location and orientation of the directional transceiver 10 are calculated.

The unit vector of the direction from the directional transceiver 10 to the object 12 can be defined as:

$${r}_{A}^{0} = [ \begin{matrix}sin {θ}_{A} cos {φ}_{A} \\ sin {θ}_{A} sin {φ}_{A} \\ cos {θ}_{A}\end{matrix} ] \qquad EQUATION 1$$

In the reference coordinate system, the object 12 is seen from the origin O_{G} in a direction of the unit vector, r_{G}⁰:

$${r}_{G}^{0} = {C}_{GA} {r}_{A}^{0} = [ \begin{matrix}sin {θ}_{G} cos {φ}_{G} \\ sin {θ}_{G} sin {φ}_{G} \\ cos {θ}_{G}\end{matrix} ] \qquad EQUATION 2$$

where C_{GA} is a direction cosine matrix which describes the rotation of the local coordinate system relative to the reference coordinate system.

Taking into account that the location of the directional transceiver 10 relative to the reference coordinate system is (a₀, b₀, c₀), the location of the object 12 using the reference coordinate system may be expressed as:

$${r}_{G} = \frac{- {c}_{0}}{cos {θ}_{G}} [ \begin{matrix}sin {θ}_{G} cos {φ}_{G} \\ sin {θ}_{G} sin {φ}_{G} \\ cos {θ}_{G}\end{matrix} ] + [ \begin{matrix}{a}_{0} \\ {b}_{0} \\ {c}_{0}\end{matrix} ] \qquad EQUATION 3$$

As discussed above, the reference coordinate system is defined such that the z-coordinate for the object 12 is equal to zero (i.e. z_{G}=0) and that the z-coordinate of the directional transceiver 10 is measured relative to the position of the object 12. As such, the location of the object 12 can be defined as:

$${r}_{G} = [ \begin{matrix}{x}_{g} \\ {y}_{g} \\ 0\end{matrix} ] = \frac{- {c}_{0}}{cos {θ}_{G}} [ \begin{matrix}sin {θ}_{G} cos {φ}_{G} \\ sin {θ}_{G} sin {φ}_{G} \\ cos {θ}_{G}\end{matrix} ] + [ \begin{matrix}{a}_{0} \\ {b}_{0} \\ {c}_{0}\end{matrix} ] \qquad EQUATION 4$$

The direction cosine matrix, C_{GA} can be written as follows:

$${C}_{GA} = [ \begin{matrix}{c}_{11} & {c}_{12} & {c}_{13} \\ {c}_{21} & {c}_{22} & {c}_{23} \\ {c}_{31} & {c}_{32} & {c}_{33}\end{matrix} ] \qquad EQUATION 5$$

where the element in the ith row and the jth column, cᵢⱼ represents the cosine of the angle between the i-axis of the reference coordinate system and the j-axis of the local coordinate system.

When the reference coordinate system comprises the global coordinate system, the direction cosine matrix, C_{GA}, can be also written as:

$${C}_{GA} = [ \begin{matrix}{N}_{A} \\ {E}_{A} \\ {G}_{A}\end{matrix} ] \qquad EQUATION 6$$

where N_{A}, E_{A} and G_{A} are [1×3] vectors defining orthogonal directions of north, east and gravity in the local coordinate system.

An alternative way to express the direction cosine matrix, C_{GA}, is through Euler angles. Euler angles represent three composed rotations that move the local coordinate system to be aligned with the reference coordinate system. The direction cosine matrix, C_{GA}, expressed through Euler angles can be seen below:

$${C}_{GA} = [ \begin{matrix}cos α cos γ & \begin{matrix}- cos β sin γ + \\ sin β sin α cos γ\end{matrix} & \begin{matrix}sin β sin γ + \\ cos β sin α cos γ\end{matrix} \\ cos α sin γ & \begin{matrix}cos β cos γ + \\ sin β sin α sin γ\end{matrix} & \begin{matrix}- sin β cos γ + \\ cos β sin α sin γ\end{matrix} \\ - sin α & sin β cos α & cos β cos α\end{matrix} ] \qquad EQUATION 7$$

Finally, putting the above together provides the following equation for the location of the object 12 relative to the reference coordinate system. It is the below equation (Equation 8) that is solved using the known location of the object 12 and the measured angular coordinates of the directional transceiver 10 to allow the location and the orientation of the directional transceiver 10 to be determined.

$$[ \begin{matrix}{x}_{G} \\ {y}_{G} \\ 0\end{matrix} ] = \frac{- {c}_{0}}{\begin{matrix}\begin{matrix}- sin α sin {θ}_{A} cos {φ}_{A} + \\ sin β cos α sin {θ}_{A} sin {φ}_{A} +\end{matrix} \\ cos β cos α cos {θ}_{A}\end{matrix}} [ \begin{matrix}cos α cos γ & \begin{matrix}- cos β sin γ + \\ sin β sin α cos γ\end{matrix} & \begin{matrix}sin β sin γ + \\ cos β sin α cos γ\end{matrix} \\ cos α sin γ & \begin{matrix}cos β cos γ + \\ sin β sin α sin γ\end{matrix} & \begin{matrix}- sin β cos γ + \\ cos β sin α sin γ\end{matrix} \\ - sin α & sin β cos α & cos β cos α\end{matrix} ] [ \begin{matrix}sin {θ}_{A} cos {φ}_{A} \\ sin {θ}_{A} sin {φ}_{A} \\ cos {θ}_{A}\end{matrix} ] + [ \begin{matrix}{a}_{0} \\ {b}_{0} \\ {c}_{0}\end{matrix} ] \qquad EQUATION 8$$

In Equation 8 location points (x_{G}, y_{G}) are known, and location parameters (a₀, b₀, c₀) and orientation parameters (α, β, γ) need be solved. Equation 8 is a set of non-linear equations and can be solved in any suitable way. For example, Equation 8 may be solved numerically using one of many available algorithms, such as the LSQNONLIN function which is available in MATLAB® from MathWorks®.

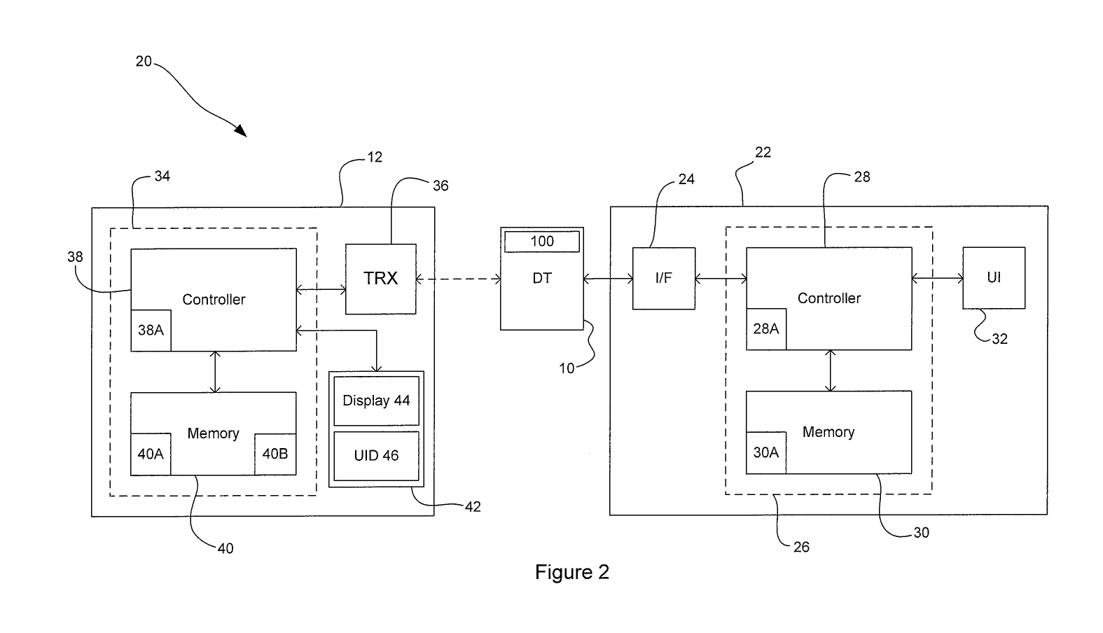

FIG. 2 is an illustrative schematic of a system 20 for enabling the post-installation determination of the location and orientation of a directional transceiver 10 relative to a reference coordinate system.

The system 20 comprises the directional transceiver 10. This is in communication with a processing infrastructure 22 which is operable to process signals received from the directional transceiver 10. The processing infrastructure 22 comprises an interface 24 which is operable to receive signals from the directional transceiver 10 and to pass these on to processing apparatus 26. The directional transceiver 10 and the interface 24 may communicate over any suitable wired or wireless connection.

The processing apparatus 26 comprises a controller 28 and at least one memory 30. The controller 28 is operable to receive signals from the directional transceiver 10 via the interface 24 and to process these signals under the control of computer readable instructions 30A stored in the at least one memory. More specifically, the controller 28 is operable to receive signals from the directional transceiver 10 and to determine therefrom angular coordinates θ_{A}, Φ_{A} of a device 12 which is in communication with the directional transceiver 10.

The controller 28 comprises at least one processor 28A (which may be referred to as processing means) which is configured to the execute computer readable instructions 30A stored in the at least one memory. The controller 28 may also comprise one or more application specific integrated circuits (not shown).

The at least one memory 30 may comprise one or more distinct memory modules or media such as, but not limited to ROM, RAM, EEPROM and flash memory.

The processing infrastructure 22 may also comprise a user interface 32 for allowing a user to provide instructions to the infrastructure 22 and/or for outputting information to the user.

The system 20 also comprises the device 12 which is operable to communicate with the directional transceiver 10 using positioning packets. In the description of FIG. 1, the device 12 was described as the object 12. The device 12 comprises processing apparatus 34 and a transceiver 36 for communicating with the directional transceiver 10. The transceiver 36 may comprise, for example, a BTLE transceiver.

The transceiver 36 of the device 12 and the directional transceiver 10 may communicate in either of two different modes. These modes are uplink, wherein the transceiver 36 of the device 12 transmits a positioning packet to the directional transceiver 10, or in downlink, wherein the directional transceiver 10 transmits a positioning packet to the transceiver 36 of the device 12. In the uplink mode, the controller 28 of the processing apparatus 26 determines the angular coordinates θ_{A}, Φ_{A} of the device 12 relative to the local coordinate system. In the downlink mode, the controller 38 of the device 12 determines the angular coordinates θ_{A}, Φ_{A} of the device 12 relative to the local coordinate system. Subsequent to determining the angular coordinates θ_{A}, Φ_{A} of the device 12, the controller 28; 38 that has determine the coordinates is operable to cause the angular coordinates θ_{A}, Φ_{A} to be stored in at least one memory 30; 40.

The processing apparatus 34 of the device 12 comprises a controller 38 and at least one memory 40. The controller 38 is operable under the control of computer readable instructions 40A stored on the at least one memory 40 to control operation of the transceiver 36. More specifically, the controller 38 may be operable to control the transceiver 36 when sending or receiving positioning packets to the directional transceiver 10.

The controller 38 comprises at least one processor 38A (which may also be referred to as processing means) which is operable to execute the computer readable instructions 40A stored on the at least one memory 40. The controller 38 may also comprise one or more application specific integrated circuits (not shown). The memory 40 may comprise one or more distinct memory modules or media which may be, for example, ROM, RAM, EEPROM or flash memory.

The at least one memory 40 of the device 12 may have stored therein a mapping application 40B which includes a map of the area in which one or more directional transceivers, including directional transceiver 10, are installed. The mapping application 40B uses the reference coordinate system, which may be the global coordinate system, based on north, east and gravity.

The device 12 may also comprise a user interface 42 which may comprise a display 44 for allowing the user of the device 12 to view the local map, which is provided when the at least one processor 38A executes the mapping application 40B. The user interface 42 may also include a user input device 12, such as, but not limited to a touch screen, a keypad, a track pad and a track ball. The controller 38 may be operable to cause a map of the area (as provided by mapping application) to be displayed on the display. The controller may be operable also to receive signals from the user input device, the signals being indicative of a user input identifying a current location of the user and the device 12. The controller 38 is responsive to these user inputs to store in the at least one memory 40 the coordinates (x_{G}, y_{G}, 0) identified by the user input.

The device 12 may comprise a portable apparatus such as a PDA, a laptop, a mobile telephone, a tablet computer or any other suitable kind of portable device.

In some example systems, the directional transceiver 10 may have associated therewith an inclinometer 100. The inclinometer 100 is operable to measure angles of tilt of the directional transceiver 10 with respect to gravity. The measured angles of tilt of the directional transceiver 10 are passed back to the processing apparatus 26 via the interface 24. The controller 28 is operable to store the measured angles of tilt along with the angular coordinates θ_{A}, Φ_{A} of the device 12 in the at least one memory 30.

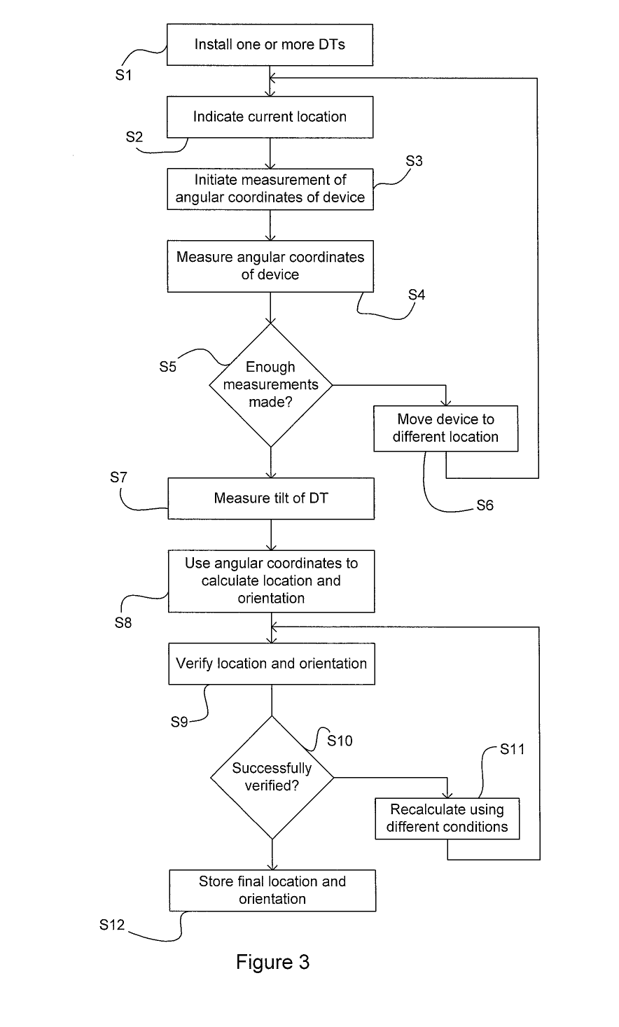

FIG. 3 is a flow diagram illustrating a method according to example embodiments of the invention.

In step S1, one or more directional transceivers 10 are installed within an area or environment. Installation of a directional transceiver 10 may comprise positioning the directional transceiver 10 at location from where it is to be used as part of a positioning system for determining the location of devices or tags within the environment or area.

The one or more directional transceivers 10 are then connected in a wired or wireless manner to the processing infrastructure 22. In embodiments in which plural directional transceivers 10 are installed, all of the transceivers 10 may be connected to a single processing infrastructure 22. Alternatively, each directional transceiver 10 may be connected to a separate processing infrastructure 22.

The directional transceivers 10 are installed within the environment without measuring their location and orientation. The coordinates of the locations of each of the one or more directional transceivers 10 are not known. The orientations of the one or more directional transceivers 10 following installation are not known.

In step S2, a user of the device 12 uses the mapping application 40B in conjunction with the user interface 44 of a device 12 to indicate the location of the device 12 relative to the reference coordinate system. The controller 38 of the device 12 is operable to cause coordinates (x_{G}, y_{G}, 0) indicative of the location of the device 12 to be stored in the at least one memory 40.

Next, in step S3, the user initiates a measurement by the directional transceiver 10 of the angular coordinates θ_{A}, Φ_{A}, of the device 12 from the directional transceiver 10. The measurement may be initiated by the controller 38 of the device causing a positioning packet to be transmitted from the transceiver 36 of the device 12 to the directional transceiver 10 (i.e. uplink mode). Alternatively, the measurement may be initiated by the device 12 communicating with the processing infrastructure 22 associated with the directional transceiver 10, thereby to cause the directional transceiver 10 to transmit a positioning packet to the transceiver 36 of the device 12 (i.e. downlink mode).

Initiation of the measurement may result from the same user input that provided the indication of the location of the device 12.

If more than one directional transceiver 10 is in range of the device 12, step S3 may comprise initiating measurements of the angular coordinates θ_{A}, Φ_{A} of the device 12 in respect of one or more of these installed directional transceivers 10 substantially simultaneously, or in succession. In this way, it is possible for the location and orientation of more than one directional transceiver 10 to be calculated concurrently or substantially simultaneously.

In step S4, if uplink mode has been used (i.e. the positioning packet has been sent from the device 12 to the DT 10), the processing infrastructure 22 responds to the initiation of step S3 by using the directional transceiver 10 to measure the angular coordinates θ_{A}, Φ_{A} of the device 12 relative to the directional transceiver 10. More specifically, the processing apparatus 26 of the processing infrastructure 22 receives signals from the directional transceiver 10 and uses these to determine the angular coordinates θ_{A}, Φ_{A} of the device 12.

Alternatively, if downlink mode has been used (i.e. the positioning packet has been sent from the DT 10 to the device 12), the controller 38 of the device responds to the initiation of step S3 by using the transceiver 36 to measure the angular coordinates θ_{A}, Φ_{A} of the device 12 relative to the directional transceiver 10. More specifically, controller 38 receives signals from the transceiver 36 and uses these to determine the angular coordinates θ_{A}, Φ_{A} of the device 12.

Next, in step S5, it is determined if a sufficient number of measurements have been made. This may simply be a determination as to whether a predetermined number of measurements have been made. The way in which the number of measurements affects the accuracy of the results is discussed below. The number of measurements that are required may depend on the number of unknown parameters that are to be solved (i.e. how many of a0, b0 and c0, and α, β and γ are not known and need to be solved). Any suitable number of measurements may be performed. For example, the number of measurements may be in the range of 5 to 20.

If it is determined in step S5 that more measurements are to be made, in step S6 the user of the device moves to a different location and the method returns to step S2.

If it is determined in step S5 that no more measurements are to be made, the method proceeds to step S7.

In step S7, the tilt of the directional transceiver 10 is measured using the inclinometer 100. The processing apparatus 26 of the processing infrastructure 22 uses the signals received from the inclinometer 100 to determine the tilt of the directional transceiver 10.

In step S8, the measured angular coordinates θ_{A}, Φ_{A} of the device 12 are used to calculate the location and orientation of the directional transceiver 10 relative to the reference coordinate system. More specifically, all the pairs of measured angular coordinates θ_{A}, Φ_{A}, together with device location coordinates (x_{G}, y_{G}, 0) corresponding to each pair, are inserted into the set of non-linear equations defined by Equation 8 (shown above). The set of non-linear equations is then solved numerically using a suitable algorithm.

Solving the set of non-linear equations produces calculated location parameters (a0, b0, c0) and orientation parameters, or Euler angles (α, β, γ), of the directional transceiver that fit best with the measured angular coordinates and corresponding device locations.

In embodiments in which the tilt angles of the directional transceiver 10 are measured through gravity vector G_{A} in local coordinates, some of the orientation parameters, namely α and β, can be solved using Equations 6 and 7. As such, these values are also inserted into Equation 8 which is then solved.

Next, in step S9, the calculated location and orientation of the directional transceiver 10 are verified. In some example embodiments, the gravity vector G_{A} obtained using the inclinometer 100 is used to verify the calculated orientation, and consequently the location. More specifically, the measured gravity vector G_{A} is compared with the third row of direction cosine matrix C_{GA} constructed from orientation parameters (α, β, γ) and shown in Equation 7. If these two vectors are within a predetermined error range, then the calculated orientation of the directional transceiver 10 can be verified as being correct. In alternative embodiments, the calculated location and orientation of the directional transceiver 10 may be verified by inserting the calculated location and orientation parameters back into Equation 8 along with the measured angular coordinates of the device 12. The location of the device 12 is then calculated. If the calculated location of the device 12 falls within a predetermined error range of the location indicated by the user in step S2, it can be verified that the orientation and location of the directional transceiver 10 have been calculated correctly.

In step S10, it is determined whether or not the calculated location and orientation of the directional transceiver 10 can be successfully verified. In other words, it is determined whether or not the location and orientation of the directional transceiver 10 have been calculated correctly. This is carried out as described above with reference to step S9.

If in step S10 it is determined that the orientation and location of the directional transceiver 10 cannot be successfully verified, for example because the measured gravity vector does not match the third row of the direction cosine matrix C_{GA} of Equation 7, the method proceeds to step S11.

Unsuccessful verification of the calculated location and orientation of the directional transceiver 10 may result from the numerical algorithm that is used to solve the set of non-linear equations defined by Equation 8 converging to a local minimum instead of a global one. This situation is not uncommon with non-linear equations. As such, in step S11, the orientation and location of the directional transceiver 10 may be recalculated using for example one or more of a different algorithm, different initial values and different boundary conditions.

Subsequent to step S11, the method returns to step S9.

If the determination in step S10 is positive, the method proceeds to step S12 in which the correctly verified location and orientation of the directional transceiver 10 relative to the reference coordinate system are stored in a memory for later use. The stored values may then be used in determining locations of devices relative to the reference coordinate system.

The calculation and verification of the location and orientation of the directional transceiver 10 may be carried out by any appropriate processing apparatus. For example, it may be carried out by the processing apparatus 26 of the processing infrastructure 22. In such embodiments, the location of the device 12, as indicated by the user in step S2, may be transmitted in a suitable manner to the processing infrastructure 22. In addition, if downlink mode has been used to determine the angular coordinates θ_{A}, Φ_{A}, these may also be transmitted from the device to the processing infrastructure 22. In other example embodiments, the calculation and verification may be performed by the processing apparatus 34 of the device 12. In such embodiments, where uplink mode has been used, the measured angular coordinates θ_{A}, Φ_{A} of the device 12 may be transmitted from the processing infrastructure 22 to the device 12. In other example embodiments, the calculation may be performed by a different processing apparatus that is not part of either the processing infrastructure 22 or the device 12. In some example embodiments, the method may be carried out using more than one processor, some of which may be provided in different devices and/or are at different locations.

In some example embodiments, the operation described above may be semi-automated. In such embodiments, subsequent to initiation in step S3, the user begins to walk at a uniform speed in a straight line. Measurements of the angular coordinates are made at predetermined intervals. Next, when the user changes direction, they mark on the map application the location at which they are changing directions. The location at which the user changes direction made be known as a “turning point”. Measurements of the angular coordinates continue to be made. The user may change direction one or more time. Finally, when the user wishes to finish taking measurements, they indicate their final location.

The controller 38; 28 is then operable to use the locations of the start point, the end point and the turning points to interpolate the location at which each measurement of the angular coordinates was made. This location information together with its associated pair of angular coordinates can be used in conjunction with Equation 8 determine the location and orientation of the directional transceiver 10.

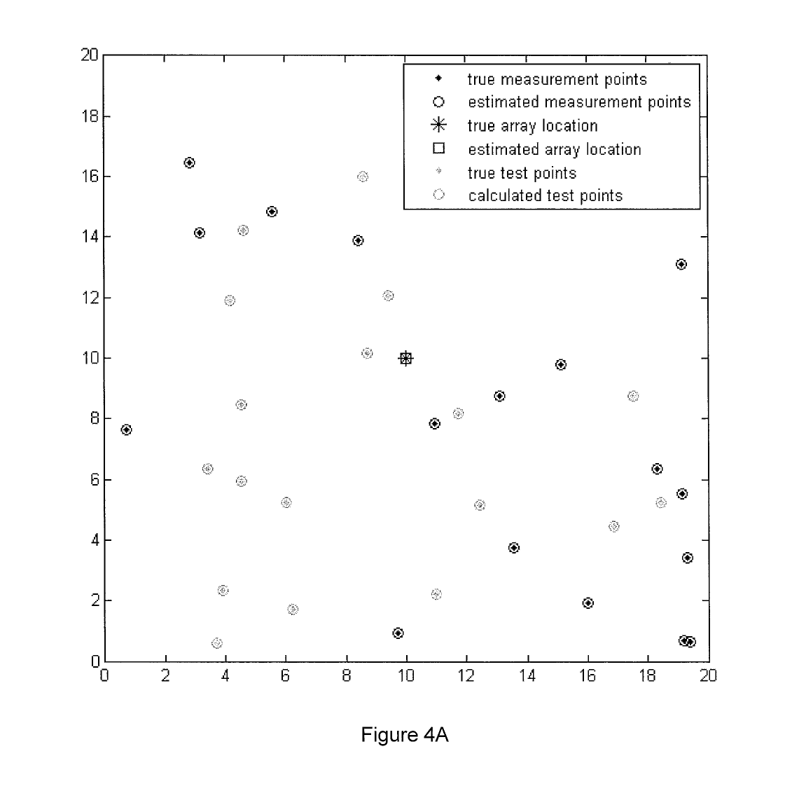

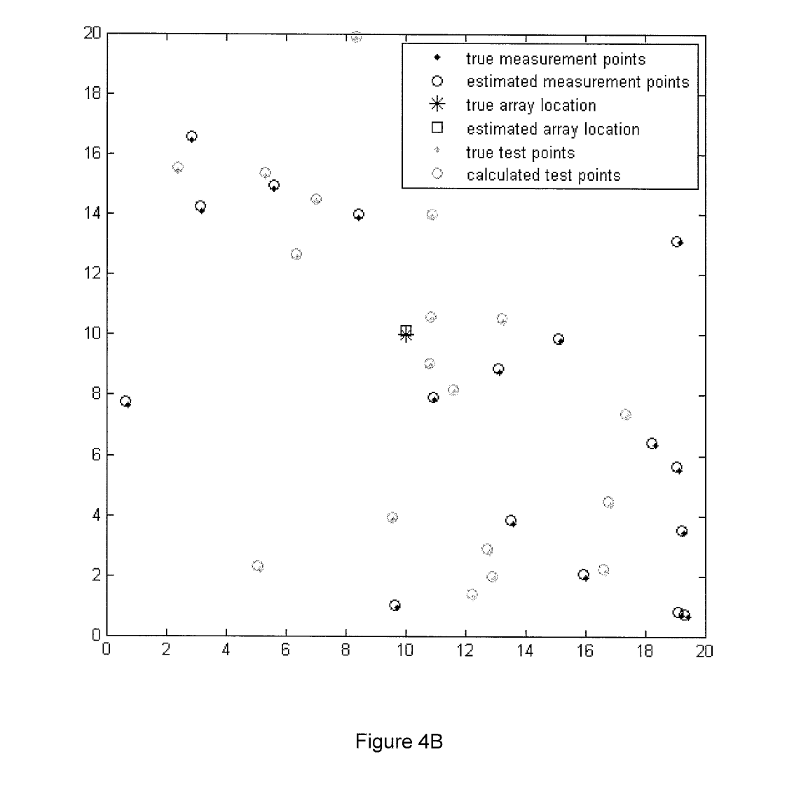

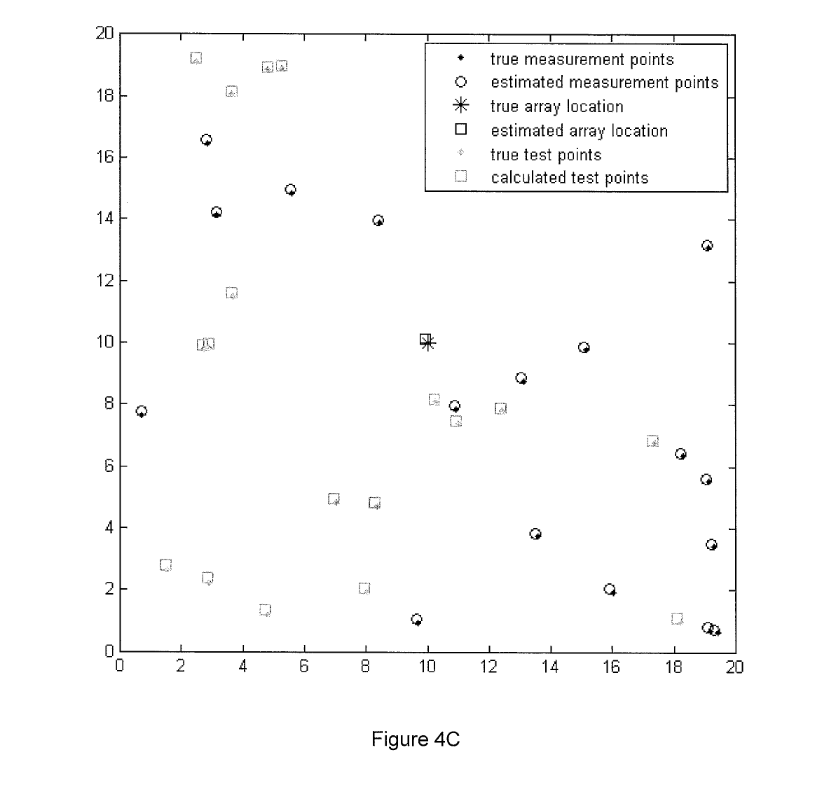

FIGS. 4A to 4C graphically depict results of simulations carried out based on the above described method.

In each of the simulations, an area or environment size of 20 metres×20 metres×20 metres is assumed. Twenty randomly generated calibration measurement points (i.e. device locations x_{G}, y_{G}, z_{G}) are used. The directional transceiver 10 is located at the centre of the theoretical environment. As described above, the reference coordinate system is selected such that the calibration measurement level is at z=0. As the z-axis direction of the reference coordinate system is downwards (as shown in FIG. 1), the location of the directional transceiver 10 is given by [10, 10, −10]. The orientation of the directional transceiver 10 is random.

The location of each calibration measurement point is known, and the angular coordinates θ_{A}, Φ_{A} from the directional transceiver 10 to the calibration measurement point can be calculated using geometry.

In the simulation, the known calibration measurement point (x_{G}, y_{G}, 0) and the calculated angular coordinates θ_{A}, Φ_{A} to the measurement point are then inserted into Equation 8, thereby allowing the location parameters (a₀, b₀, c₀) and orientation parameters (α, β, γ) to be solved.

Each of FIGS. 4A to 4C includes the following information:
“estimated array location” which refers to the calculated location of the directional transceiver 10;
“true measurement points” which refer to the calibration measurement points from which the device 12 initiates measurement of its angular coordinates θ_{A}, Φ_{A} relative to the directional transceiver 10 in order to determine the location and orientation of the directional transceiver 10;
“estimated measurement points” which refer to the calibration measurement points as obtained by inserting the calculated location and orientation of the directional transceiver 10 and the angular coordinates θ_{A}, Φ_{A} back into Equation 8 (i.e. as obtained when verifying the calculated location and orientation);
“true test points” which refer to randomly generated test points from which device location measurements were made, and that have not been used in calibration; and
“calculated test points” which refer to the locations of the true test points as calculated using the location and orientation of the directional transceiver, which were calculated during calibration.

FIG. 4A shows the simulation results when the locations of the calibration measurement points are known exactly, without measurement error. It can be seen from FIG. 4A that, in a simulation in which no error exists, the above described method allows the location parameters of the directional transceiver 10 to be calculated correctly with no error. In addition, although not shown in FIG. 4A, when no errors in calibration measurement points exist, the orientation parameters (e.g. the Euler angles) of the directional transceiver 10 are calculated correctly, with no error.

FIG. 4B shows the simulation results when the locations of the calibration measurement points contain measurement errors of a standard deviation of 0.2 meters in both the x and y directions, and when all of the location parameters and the orientation parameters are solved using Equation 8 (i.e. when tilt angles from an inclinometer 100 are not used). The known and solved direction cosine matrix and the solved array location can be seen below. The known direction cosine matrix is generated using the known, randomly generated Euler angles with Equation 7. The solved direction cosine matrix is generated using the calculated Euler angle of the directional transceiver 10 with Equation 7:

$$Known {C}_{GA} = [ \begin{matrix}0.7463 & - 0.6631 & - 0.0583 \\ 0.0256 & 0.1162 & - 0.9929 \\ 0.6651 & 0.7395 & 0.1037\end{matrix} ]$$

$$Solved {C}_{GA} = [ \begin{matrix}0.7431 & - 0.6662 & - 0.0626 \\ 0.0207 & 0.1163 & - 0.9930 \\ 0.6688 & 0.7366 & 0.1002\end{matrix} ]$$

$$Solved ( {a}_{0} , {b}_{0} , {c}_{0} ) = ( 10.0165 , 10.1423 , - 9.9791 )$$

FIG. 4C shows the simulation results when the calibration measurement points contain measurement errors with a standard deviation of 0.2 meters in both the x and y directions and when a theoretical inclinometer is used to provide two of the orientation parameters (α and β), thereby meaning that only four (i.e. γ and a₀, b₀ and c₀), and not six, of the orientation and location parameters need to be solved.

Below are the known and calculated values for the direction cosine matrix in addition to the calculated array location:

$$Known {C}_{GA} = [ \begin{matrix}0.7463 & - 0.6631 & - 0.0583 \\ 0.0256 & 0.1162 & - 0.9929 \\ 0.6651 & 0.7395 & 0.1037\end{matrix} ]$$

$$Solved {C}_{GA} = [ \begin{matrix}0.7464 & - 0.6627 & - 0.0616 \\ 0.0231 & 0.1184 & - 0.9927 \\ 0.6651 & 0.7395 & 0.1037\end{matrix} ]$$

$$Solved ( {a}_{0} , {b}_{0} , {c}_{0} ) = ( 9.9531 , 10.1042 , - 9.9683 )$$

Tables 1 and 2 below illustrate the effect of using an inclinometer on the quality of the results.

TABLE 1

| # Calibration points | E1 (metres) | E2 (metres) | E3 (metres) |
|---|---|---|---|
| 5 | 0.13 | 0.34 | 0.74 |
| 10 | 0.22 | 0.15 | 0.28 |
| 15 | 0.23 | 0.10 | 0.20 |

TABLE 2

| # Calibration points | E1 (metres) | E2 (metres) | E3 (metres) |
|---|---|---|---|
| 5 | 0.20 | 0.18 | 0.18 |
| 10 | 0.21 | 0.13 | 0.13 |
| 15 | 0.24 | 0.09 | 0.09 |

Both tables show, in column E1, the mean error of re-calculated measurement point locations, in column E2, the mean error of newly generated test point locations (i.e. locations not used in calibration), and in column E3, the mean error in the estimated location of the directional transceiver 10. Each table comprises three rows with the first row showing the respective mean errors where five calibration points were used, the second row shows the mean errors where ten calibration points were used, and the third row shows the mean error where twenty calibration points were used.

It can be seen from a comparison of Tables 1 and 2 that, when an inclinometer was used, the location of the directional transceiver 10 can be calculated with a relatively high degree of accuracy even when a fairly small number of calibration points were used. In addition, although not clear from Tables 1 and 2, it was noticed by the inventors that using an inclinometer considerably reduces occurrences in which a local and not a global minimum solution to Equation 8 was found by algorithm.

In the above examples, the device 12 is operable to execute a mapping application 40B, which allows a user to mark the current location, where a calibration measurement is to be made. In other embodiments, however, the device 12 may not have this functionality. Instead, it may just be able to communicate with the directional transceiver to its angular coordinates to be determined. The location of the device may not be indicated by the user, but may instead be a predetermined calibration point, the coordinates of which are already known. The device 12 may be operable to cause the measurement of the angular coordinates to be initiated, for example, in response to a user input. Alternatively, the initiation of measurement may be automatic, for example in response to a timer, with the user carrying the device 12 to a predetermined location at a predetermined time at which the measurement is to be made.

In the above examples, at least one parameter of both the location and orientation of the DT 10 is unknown. However, it will be appreciated that the above-described methods and systems are also applicable in a situation where all of the parameters of one of the location and orientation of the DT 10 are known. This may occur, for example, when a DT 10 is installed at a known pre-selected location, but wherein the orientation is not known. Similarly, it may occur where the orientation is known, for example because the orientation of the surface onto which the DT 10 is to be mounted is known, but the location is unknown, for example, because the installer was free to choose the exact location on the surface. As will be understood, the more parameters that are known, the fewer the number of calibration measurements that may be required in order to achieve a sufficiently accurate determination of the location and/or the orientation.

It should be realized that the foregoing embodiments should not be construed as limiting. Other variations and modifications will be apparent to persons skilled in the art upon reading the present application. Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1-41. (canceled)

42. A method comprising:
measuring angular coordinates of an object relative to a directional transceiver, the directional transceiver being at a first location relative to a reference coordinate system and having an orientation relative to the reference coordinate system, the object being at a second, known location, the angular coordinates being measured relative to an axis of a local coordinate system, the orientation of the local coordinate system being defined by the orientation of the directional transceiver and the origin of the local coordinate system being at the first location, wherein at least one of the first location and the orientation of the directional transceiver are unknown; and
calculating the unknown at least one of the first location and the orientation of the directional transceiver using the angular coordinates.

43. The method of claim 42, wherein the orientation of the directional transceiver is unknown and the directional transceiver is equipped with an inclinometer, the method comprising:
measuring the tilt of the directional transceiver using the inclinometer; and
calculating, using the angular coordinates and the tilt, the orientation of the directional transceiver and the first location if the first location was previously unknown.

44. The method of claim 42, wherein the orientation of the directional transceiver is unknown and the directional transceiver is equipped with an inclinometer, the method comprising:
measuring the tilt of the directional transceiver using the inclinometer; and
using the tilt to verify the calculated orientation of the directional transceiver and, if the first location was calculated, to verify the first location.

45. The method of claim 42, comprising:
verifying the calculated at least one of the first location and the orientation of the directional transceiver by calculating a value for the second location using the first location, the orientation of the directional transceiver and the measured angular coordinates of the object.

46. The method of claim 45, comprising:
if the calculated value for the second location does not fall within an allowed error range from the actual second location, re-calculating the at least one of the first location and the orientation of the directional transceiver using the angular coordinates, the re-calculation being performed differently to the prior calculation of the at least one of the first location and orientation of the directional transceiver.

47. The method of claim 42, wherein calculating the at least one of the first location and the orientation of the directional transceiver comprises solving the following equation:
$$[ \begin{matrix}{x}_{G} \\ {y}_{G} \\ {z}_{G}\end{matrix} ] = \frac{- {c}_{0}}{\begin{matrix}\begin{matrix}- sin α sin {θ}_{A} cos {φ}_{A} + \\ sin β cos α sin {θ}_{A} sin {φ}_{A} +\end{matrix} \\ cos β cos α cos {θ}_{A}\end{matrix}} {C}_{GA} {r}_{A}^{0} + [ \begin{matrix}{a}_{0} \\ {b}_{0} \\ {c}_{0}\end{matrix} ]$$
$$where \text{:}$$
$${C}_{GA} = [ \begin{matrix}cos α cos γ & \begin{matrix}- cos β sin γ + \\ cos β sin α cos γ\end{matrix} & \begin{matrix}sin β sin γ + \\ cos β sin α cos γ\end{matrix} \\ cos α sin γ & \begin{matrix}cos β cos γ + \\ sin β sin α sin γ\end{matrix} & \begin{matrix}- sin β cos γ + \\ cos β sin α sin γ\end{matrix} \\ - sin α & sin β cos α & cos β cos α\end{matrix} ] ;$$
$${r}_{A}^{0} = [ \begin{matrix}sin {θ}_{A} cos {φ}_{A} \\ sin {θ}_{A} sin {φ}_{A} \\ cos {θ}_{A}\end{matrix} ] ;$$
(a₀, b₀, c₀)=the coordinates of the first location;
(x_{G}, y_{G}, z_{G})=the coordinates of the second, known location;
(α, β, γ)=the Euler angles from the reference coordinate system to the local coordinate system; and
θ_{A} and Φ_{A}=the angular coordinates of the object relative to the z-axis of the reference coordinate system.

48. The method of claim 42, wherein the object is a portable device, the method comprising:
receiving at the portable device, a user input indicative of the second location; and
receiving at the portable device, a user input to initiate measurement of the angular coordinates using the directional transceiver.

49. The method of claim 45, comprising:
measuring a plurality of pairs of angular coordinates, each pair being measured when the object is at a different second location;
calculating using the plurality of pairs of angular coordinates, the unknown at least one of the first location and the orientation of the directional transceiver.

50. The method of claim 49, comprising:
automatically measuring the pairs of angular coordinates at predetermined time intervals between a known start time at which the object is at a start location and an end time at which the object is at an end location, the start location being different to the end location; and
using interpolation to determine the different second locations for each measured pair of angular coordinates using the start location and the end location,
wherein the object moves at a substantially uniform speed between the start location and the end location and wherein the path along which the object moves between the start location and the end location is substantially straight.

51. The method of claim 42, wherein the method is performed substantially concurrently for at least two directional transceivers, each being at a different first location.

52. Apparatus comprising:
at least one processor; and
at least one memory, the at least one memory having stored thereon computer-readable instructions which, when executed by the at least one processor, cause the at least one processor:
to receive signals indicative of angular coordinates of an object relative to a directional transceiver, the directional transceiver being at a first location relative to a reference coordinate system and having an orientation relative to the reference coordinate system, the object being at a second, known location relative to the reference coordinate system, the angular coordinates being measured relative to an axis of a local coordinate system, the orientation of the local coordinate system being defined by the orientation of the directional transceiver and the origin of the local coordinate system being at the first location, wherein at least one of the first location and the orientation of the directional transceiver are unknown; and
to calculate the unknown at least one of the first location and the orientation of the directional transceiver using the angular coordinates.

53. The apparatus of claim 52, wherein the orientation of the directional transceiver is unknown and the directional transceiver is equipped with an inclinometer and wherein the computer-readable instructions, when executed by the at least one processor, cause the at least one processor:
to receive signals indicative of the tilt of the directional transceiver from the inclinometer; and
to calculate, using the angular coordinates and the tilt, the orientation of the directional transceiver and the first location if the first location was previously unknown.

54. The apparatus of claim 52, wherein the orientation of the directional transceiver is unknown and the directional transceiver is equipped with an inclinometer, and wherein the computer-readable instructions, when executed by the at least one processor, cause the at least one processor:
to receive signals indicative of the tilt of the directional transceiver using the inclinometer; and
to use the tilt to verify the calculated orientation of the directional transceiver and, if the first location was calculated, to verify the first location.

55. The apparatus of claim 52 wherein the computer-readable instructions, when executed by the at least one processor, cause the at least one processor: to verify the calculated at least one of the first location and the orientation of the directional transceiver by calculating a value for the second location using the first location, the orientation of the directional transceiver and the measured angular coordinates of the object.

56. The apparatus of claim 55, wherein the computer-readable instructions, when executed by the at least one processor, cause the at least one processor:
if the calculated value for the second location does not fall within an allowed error range from the actual second location, to re-calculate the at least one of the first location and the orientation of the directional transceiver using the angular coordinates, the re-calculation being performed differently to the prior calculation of the at least one of the first location and orientation of the directional transceiver.

57. The apparatus of claim 52, wherein the computer-readable instructions, when executed by the at least one processor, cause the at least one processor:
to calculate the at least one of the first location and the orientation of the directional transceiver by solving the following equation:
$$[ \begin{matrix}{x}_{G} \\ {y}_{G} \\ {z}_{G}\end{matrix} ] = \frac{- {c}_{0}}{\begin{matrix}\begin{matrix}- sin α sin {θ}_{A} cos {φ}_{A} + \\ sin β cos α sin {θ}_{A} sin {φ}_{A} +\end{matrix} \\ cos β cos α cos {θ}_{A}\end{matrix}} {C}_{GA} {r}_{A}^{0} + [ \begin{matrix}{a}_{0} \\ {b}_{0} \\ {c}_{0}\end{matrix} ]$$
$$where \text{:}$$
$${C}_{GA} = [ \begin{matrix}cos α cos γ & \begin{matrix}- cos β sin γ + \\ cos β sin α cos γ\end{matrix} & \begin{matrix}sin β sin γ + \\ cos β sin α cos γ\end{matrix} \\ cos α sin γ & \begin{matrix}cos β cos γ + \\ sin β sin α sin γ\end{matrix} & \begin{matrix}- sin β cos γ + \\ cos β sin α sin γ\end{matrix} \\ - sin α & sin β cos α & cos β cos α\end{matrix} ] ;$$
$${r}_{A}^{0} = [ \begin{matrix}sin {θ}_{A} cos {φ}_{A} \\ sin {θ}_{A} sin {φ}_{A} \\ cos {θ}_{A}\end{matrix} ] ;$$
(a₀, b₀, c₀)=the coordinates of the first location;
(x_{G}, y_{G}, z_{G})=the coordinates of the second, known location;
(α, β, γ)=the Euler angles from the reference coordinate system to the local coordinate system; and
θ_{A} and Φ_{A}=the angular coordinates of the object relative to the z-axis of the reference coordinate system.

58. The apparatus of claim 52, wherein the computer-readable instructions, when executed by the at least one processor, cause the at least one processor:
to receive signals indicative of a plurality of pairs of angular coordinates, each pair being measured when the object is at a different second location;
to calculate, using the plurality of pairs of angular coordinates, the unknown at least one of the first location and the orientation of the directional transceiver.

59. The apparatus of claim 58, wherein the computer-readable instructions, when executed by the at least one processor, cause the at least one processor:
automatically to receive the signals indicative of the pairs of angular coordinates, the pairs of angular coordinates being measured at predetermined time intervals between a known start time at which the object is at a start location and an end time at which the object is at an end location, the start location being different to the end location; and
to use interpolation to determine the different second locations for each measured pair of angular coordinates using the start location and the end location,
wherein the object moves at a substantially uniform speed between the start location and the end location and wherein the path along which the object moves between the start location and the end location is substantially straight.

60. A non-transitory computer-readable medium having stored thereon computer-readable instructions which, when executed by computing apparatus, cause the computing apparatus to:
to measure angular coordinates of an object relative to a directional transceiver, the directional transceiver being at a first location relative to a reference coordinate system and having an orientation relative to the reference coordinate system, the object being at a second, known location relative to the reference coordinate system, the angular coordinates being measured relative to an axis of a local coordinate system, the orientation of the local coordinate system being defined by the orientation of the directional transceiver and the origin of the local coordinate system being at the first location, wherein at least one of the first location and the orientation of the directional transceiver are unknown; and
to calculate the unknown at least one of the first location and the orientation of the directional transceiver using the angular coordinates.

61. The non-transitory computer-readable medium of claim 60, wherein the orientation of the directional transceiver is unknown and the directional transceiver is equipped with an inclinometer and wherein the computer-readable instructions, when executed by the computing apparatus, cause the computing apparatus:
to measure the tilt of the directional transceiver using the inclinometer; and
to calculate, using the angular coordinates and the tilt, the orientation of the directional transceiver and the first location if the first location was previously unknown.

62. The non-transitory computer-readable medium of claim 60, wherein the orientation of the directional transceiver is unknown and the directional transceiver is equipped with an inclinometer and wherein the computer-readable instructions, when executed by the computing apparatus, cause the computing apparatus:
to measure the tilt of the directional transceiver using the inclinometer; and
to use the tilt to verify the calculated orientation of the directional transceiver and, if the first location was calculated, to verify the first location.

63. Computer-readable code which, when executed by computing apparatus, causes the computing apparatus to perform the following when executed by a processor:
to measure angular coordinates of an object relative to a directional transceiver, the directional transceiver being at a first location relative to a reference coordinate system and having an orientation relative to the reference coordinate system, the object being at a second, known location relative to the reference coordinate system, the angular coordinates being measured relative to an axis of a local coordinate system, the orientation of the local coordinate system being defined by the orientation of the directional transceiver and the origin of the local coordinate system being at the first location, wherein at least one of the first location and the orientation of the directional transceiver are unknown; and
to calculate the unknown at least one of the first location and the orientation of the directional transceiver using the angular coordinates.

64. Computer-readable code which, when executed by computing apparatus, causes the computing apparatus to perform the following when executed by a processor according to claim 63: wherein the orientation of the directional transceiver is unknown and the directional transceiver is equipped with an inclinometer and wherein the computer-readable instructions, when executed by the computing apparatus, cause the computing apparatus:
to measure the tilt of the directional transceiver using the inclinometer; and
to calculate, using the angular coordinates and the tilt, the orientation of the directional transceiver and the first location if the first location was previously unknown.
